(19) United States
(12) Patent Application Publication
(10) Pub. No.: US 2019/0354721 A1
(43) Pub. Date: Nov. 21, 2019

(54) Techniques For Limiting Risks In Electronically Communicating Patient Information

(71) Applicant: Michigan Health Information Network Shared Services, East Lansing, MI (US)

(72) Inventors: Jeffrey A. LIVESAY, Winston-Salem, NC (US); Timothy A. PLETCHER, Mount Pleasant, MI (US)

(73) Assignee: Michigan Health Information Network Shared Services, East Lansing, MI (US)

(21) Appl. No.: 16/414,426

(22) Filed: May 16, 2019

Related U.S. Application Data
(60) Provisional application No. 62/672,858, filed on May 17, 2018.

(51) Int. Cl. G06F 21/62; G06Q 40/08

(52) U.S. Cl. CPC G06F 21/6263; G06Q 40/08

(57) ABSTRACT

Techniques for limiting risks in electronically communicating patient information are disclosed. In one particular embodiment, the techniques may be realized as a method for limiting risks in electronically communicating patient information according to a set of instructions stored on a memory of a computing device and executed by a processor of the computing device, the method comprising the steps of: determining a number of electronic security related services employed by a healthcare provider that electronically communicates patient information; calculating a level of coverage of a liability insurance to be provided to the healthcare provider based on the number of services; and calculating a premium cost of the liability insurance based on the number of services.

### CROSS-REFERENCE TO RELATED APPLICATIONS

This patent application claims priority to U.S. Provisional Patent Application No. 62/672,858, filed May 17, 2018, which is hereby incorporated by reference herein in its entirety.

This patent application is related to: U.S. patent application Ser. No. 14/643,910, filed Mar. 10, 2015, entitled Methods and Systems for Common Key Services; U.S. patent application Ser. No. 15/847,506, filed Dec. 19, 2017, entitled Dynamic Network of Active Relationships with Semantic Information; U.S. patent application Ser. No. 15/961,605, filed Apr. 24, 2018, entitled Secure, Accurate, and Efficient Patient Intake Systems and Methods; and U.S. patent application Ser. No. 15/977,690, filed May 11, 2018, entitled Systems and Methods for Managing Data Privacy, each of which is hereby incorporated by reference herein in its entirety.

### FIELD OF THE DISCLOSURE

The present disclosure relates generally to limiting risks in electronic communication and, more particularly, to techniques for limiting risks in electronically communicating patient information.

### BACKGROUND OF THE DISCLOSURE

It is common for parties that provide and receive services to communicate with each other via electronic media. For example, the parties may communicate with each other through electronic media, such as electronic mail (email). In another example, one party may maintain storage, and allow visiting parties to access the storage via a retrieving protocol, such as a File Transfer Protocol (FTP). As more sensitive information gets communicated electronically, the parties must take precautions to ensure privacy and safeguard of the information.

Some of these precautions may be mandated or required by federal laws or regulations. In particular, statutes may dictate that, when information is passed from one party to another (e.g., from a first healthcare provider to a second healthcare provider), certain security and privacy concerns be maintained through protective techniques such as encryption to reduce the likelihood of security breaches and violations of privacy regulations through the disclosure of personal health information (PHI). For instance, in healthcare, two mandates affecting patient information are required by federal statute—the Health Information Portability and Accountability Act (HIPAA) and the Health Information Technology for Economic and Clinical Health Act (HITECH) Act. Accordingly, various healthcare services, providers and stakeholders have been implementing processes and methods to ensure that handling and communication of patient information are secure.

To that end, the Office of the National Coordinator (ONC) established the Direct Project, which defines a standard protocol for secure messaging by email. The Direct protocol allows participants to send authenticated, secure messages containing encrypted health information to known, trusted recipients over the Internet. In essence, the Direct protocol creates a closed network, where only verified and trusted participants may communicate with one another. The Direct protocol employs the use of secure Simple Mail Transfer Protocol (SMTP) to facilitate the sending of messages from one party to another and requires special digital security certificates for the encryption/decryption.

Additionally, each healthcare provider that shares patient information electronically may be registered with a Health Information Service Provider (HISP). A HISP is similar to an Internet Service Provider (ISP), but specializes in Direct secure messaging (secure email). One HISP may service many healthcare entities. Several HISPs may be established, and communication between HISPs may be performed employing a closed network messaging protocol, such as the Direct protocol. Each healthcare provider may have a unique identifier granted by one of the HISPs, and use the unique identifier to communicate with other healthcare providers. A HISP may also provide services to allow healthcare providers to safely collect, maintain, and store patient information.

Despite healthcare providers taking appropriate precautions, patient information may accidentally be mishandled (e.g., by being sent to a healthcare provider or a patient who does not have the need-to-know). Moreover, given that hacking is omnipresent in the cyber world, patient information may be hacked and divulged to wrong entities or people. Therefore, it is likely that patients, whose become or are made aware of the mishandling or hacking of their personal and health information, would bring lawsuits against healthcare providers for being negligent in not taking adequate measures in safeguarding their information. It is thus in the interest of healthcare providers to insure themselves against such liabilities. However, as in any insurance paradigm, even if healthcare providers were to employ the best precautions available to them, these healthcare providers would bear the costs of high premiums resulting from some other healthcare providers not taking adequate precautions, rendering patient information more prone to mishandling or hacking.

In view of the foregoing, it may be understood that there is a need for providing liability insurance to healthcare providers that electronically communicate patient information. Moreover, it may be desirable for providers of such liability insurance to be capable of adjusting the level of coverage and premiums available to each healthcare provider based on the level of precautions taken by the healthcare provider.

### SUMMARY OF THE DISCLOSURE

Techniques for limiting risks in electronically communicating patient information are disclosed. In one particular embodiment, the techniques may be realized as a method for limiting risks in electronically communicating patient information according to a set of instructions stored on a memory of a computing device and executed by a processor of the computing device, the method comprising the steps of: determining a number of electronic security related services employed by a healthcare provider that electronically communicates patient information; calculating a level of coverage of a liability insurance to be provided to the healthcare provider based on the number of services; and calculating a premium cost of the liability insurance based on the number of services.

In accordance with other aspects of this particular embodiment, the services may include one or more of an active care relationship service (ACRS), a common key service, and an electronic consent (eConsent) management service.

In accordance with other aspects of this particular embodiment, the services may be provided by a health information service provider (HISP).

In accordance with other aspects of this particular embodiment, the services may ensure that patient information communicated by the healthcare provider conforms to data standards and security measures.

In accordance with other aspects of this particular embodiment, the calculated premium cost may be lower when the healthcare provider uses more services.

In accordance with other aspects of this particular embodiment, the calculated premium cost may be higher when the healthcare provider uses fewer services.

In accordance with other aspects of this particular embodiment, the calculated level of coverage may be higher when the healthcare provider uses more services.

In accordance with other aspects of this particular embodiment, the calculated level of coverage may be lower when the healthcare provider uses fewer services.

In another particular embodiment, the technique may be realized as a system for limiting risks in electronically communicating patient information comprising one or more processors communicatively coupled to a network; wherein the one or more processors are configured to perform the steps in the above-described method.

In another particular embodiment, the technique may be realized as an article of manufacture for limiting risks in electronically communicating patient information, the article of manufacture comprising at least one processor readable storage medium and instructions stored on the at least one medium, wherein the instructions are configured to be readable from the at least one medium by at least one processor and thereby cause the at least one processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a flow diagram illustrating a method for determining the level of coverage and premium of a liability insurance to be provided to a healthcare provider in accordance with an embodiment of the present disclosure.

FIG. 2 is a block diagram illustrating an exemplary computing device in accordance with an embodiment of the present disclosure.

FIG. 3 illustrates an exemplary system for collecting, maintaining, and updating patient information in accordance with an embodiment of the present disclosure.

FIG. 4 is a flow diagram illustrating a method for generating a common key for known persons in accordance with an embodiment of the present disclosure.

FIG. 5 is a flow diagram illustrating a method for generating a common key for unknown persons in accordance with an embodiment of the present disclosure.

FIG. 6 is a flow diagram illustrating a method for utilizing a known common key for a known person in accordance with an embodiment of the present disclosure.

FIG. 7 is a flow diagram illustrating a method for acquiring records using a common key in accordance with an embodiment of the present disclosure.

FIG. 8 is a flow diagram illustrating a method for verifying potential person matches in accordance with an embodiment of the present disclosure.

FIG. 9 is a flow diagram illustrating a method for updating files using a common key service in accordance with an embodiment of the present disclosure.

FIG. 10 is a flow diagram illustrating a method for utilizing a common key service in conjunction with a patient's hospital visit in accordance with an embodiment of the present disclosure.

FIG. 11 is a flow diagram illustrating a method for utilizing a common key service in accordance with an embodiment of the present disclosure.

FIG. 12 is a flow diagram illustrating a new patient's intake process at a health organization or a provider in accordance with an embodiment of the present disclosure.

FIG. 13 illustrates a consent management system in accordance with an embodiment of the present disclosure.

FIG. 14 illustrates a first example graphical user interface (GUI) that can be provided to a patient in accordance with an embodiment of the present disclosure.

FIG. 15 illustrates a second example GUI that can be provided to a patient in accordance with an embodiment of the present disclosure.

FIG. 16 illustrates a third example GUI that can be provided to a patient in accordance with an embodiment of the present disclosure.

FIG. 17 illustrates a fourth example GUI that can be provided to a patient in accordance with an embodiment of the present disclosure.

FIG. 18 illustrates a flowchart of a first example method for managing data privacy in accordance with an embodiment of the present disclosure.

### DETAILED DESCRIPTION OF EMBODIMENTS

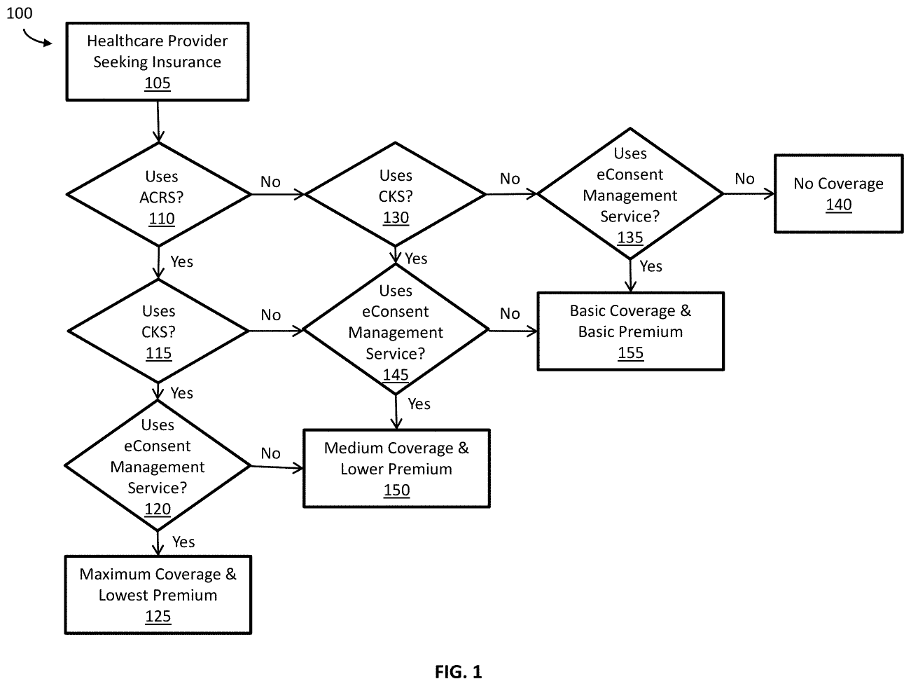

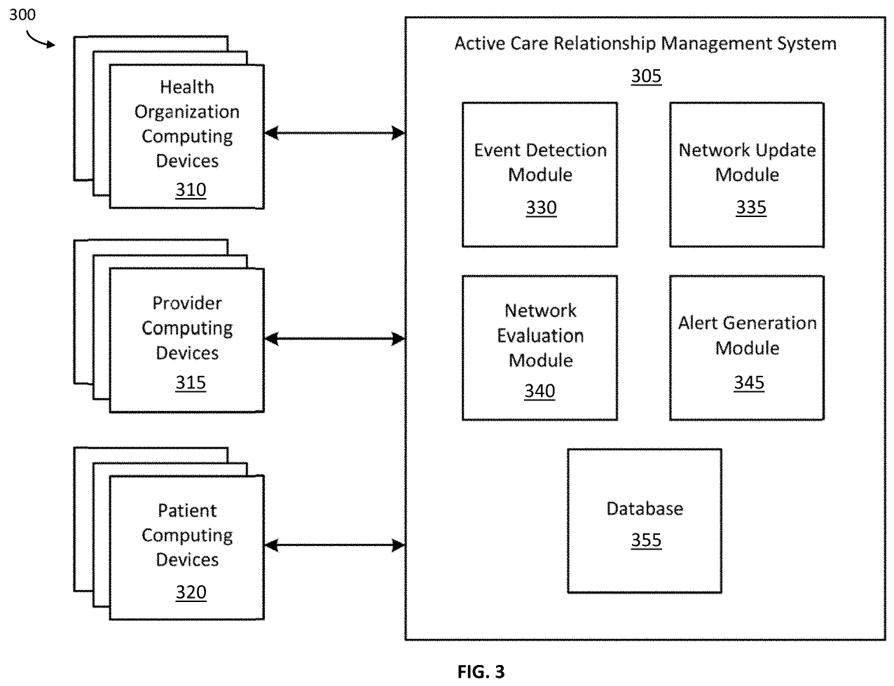

Referring to FIG. 1, there is shown a flow diagram illustrating a method 100 for determining the level of coverage and premium of a liability insurance to be provided to a healthcare provider in accordance with an embodiment of the present disclosure. The term “liability insurance” as used herein may include cyber liability insurance. A healthcare provider may include a hospital, a health plan, a medical insurer, a laboratory, a prescription benefit manager, a pharmacy, or a clinic. In FIG. 1, the level of coverage and premium are affected by the number of services that the healthcare provider uses, the services being provided by a Health Information Service Provider (HISP) or some other standardized entity. Although three services—Active Care Relationship Service (ACRS), Common Key Service (CKS), and electronic consent (eConsent) management service—are shown in FIG. 1, the method 100 is not limited to these services and may be augmented with additional services provided by one or more HISPs or other entities. The ACRS, CKS, and eConsent management service will be described in more details below, with respect to FIGS. 3-18.

The method 100 starts at operation 105 with a healthcare provider that is seeking liability insurance for risks related to communicating patient information electronically. The method 100 involves determining which of the ACRS, CKS, and eConsent management service the healthcare provider uses. If the healthcare provider uses all three services—through affirmative determinations in operations 110-120—, then the method 100 determines at operation 125 that a maximum coverage and a lowest insurance premium may be provided to the healthcare provider. If the healthcare provider uses two out of the three services—determined through operations (110 Yes, 115 No, and 145 Yes) or (110 No, 130 Yes, and 145 Yes)—, then the method 100 determines at operation 150 that a medium coverage and a premium lower than a basic premium may be provided to the healthcare provider. If the healthcare provider uses one out of the three services—determined through operations (110 Yes, 115 No, and 145 No) or (110 No, 130 No, and 135 Yes)—, then the method 100 determines at operation 155 that a basic coverage and the basic premium may be provided to the healthcare provider. Finally, if the healthcare does not use any of the three services provided the HISPs—through negative determinations in operations 110, 130, and 135—, then the method 100 determines at operation 140 that no insurance coverage may be provided to the healthcare provider.

The concept behind the method 100 is that, the more services a healthcare uses, the better coverage an insurance provider can provide at the lowest premium. As a healthcare provider uses more standardized services from one or more HISPs or other certified entities, the higher confidence an insurance provider will have in the conformance and robustness of the patient information being collected, transported and stored to data standards as specified in detailed implementation guides (e.g., in accordance with HL7 standards), and the security measures surrounding the collection, transportation, and storage of the patient information.

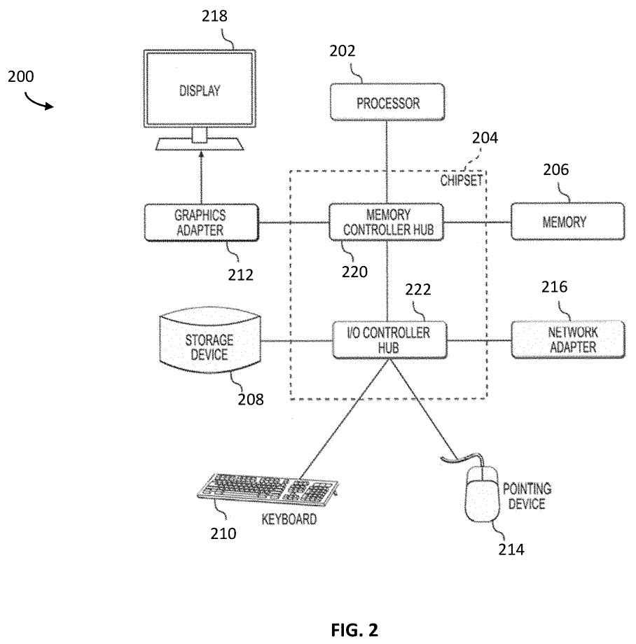

The method 100 may be implemented as at least one of a server, a desktop computer, a laptop computer, a tablet computing device, or a handheld computing device. FIG. 2 is a block diagram illustrating an exemplary computing device 200 in accordance with an embodiment of the present disclosure. In alternative embodiments, fewer, additional, and/or different components may be present. The computing device 200 may be any computing machine, such as a tablet, smart phone, laptop computer, desktop computer, server, remote client device, gaming device, smart television device, wearable computer, or any combination thereof. The computing device 200 may include at least one processor 202 coupled to a chipset 204. The chipset 204 may include a memory controller hub 220 and an input/output (I/O) controller hub 222. A memory 206 and a graphics adapter 212 may be coupled to the memory controller hub 220, and a display 218 may be coupled to the graphics adapter 212. A storage device 208, a keyboard 210, a pointing device 214, and a network adapter 216 may be coupled to the I/O controller hub 222. Other embodiments of the computing device 200 may have different architectures.

The storage device 208 may be a non-transitory computer-readable storage medium such as a hard drive, compact disk read-only memory (CD-ROM), DVD, or a solid-state memory device (e.g., read only memory (ROM) and random access memory (RAM)). The memory 206 may hold instructions and data that may be used by the processor 202. The pointing device 214 may be a mouse, a track ball, or other type of pointing device, and may be used in combination with the keyboard 210 to input data into the computing device 200. The pointing device 214 may also be a gaming system controller, or any type of device used to control a gaming system. For example, the pointing device 214 may be connected to a video or image capturing device that employs biometric scanning to detect a specific user. The specific user may employ motion or gestures to command the point device 214 to control various aspects of the computing device 200. The graphics adapter 212 may display images and other information on the display 218. To enhance interaction with a user, the herein disclosed embodiments may be implemented using an interactive display, such as a graphical user interface (GUI). Such GUIs may include interactive features such as pop-up or pull-down menus or lists, selection tabs, and other features that may receive human inputs. The network adapter 216 may couple the computer system device 200 to one or more computer networks.

The computing device 200 may be adapted to execute one or more computer programs for providing functionality described herein. A computer program (also known as a program, module, engine, software, software application, script, or code) may be written in any form of programming language, including compiled or interpreted languages, declarative or procedural languages, and the program may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computing device 200 or on multiple computing devices 200 that may be located at one site or distributed across multiple sites and interconnected by a communication network. In one embodiment, program modules may be stored into the storage device 208, loaded into the memory 206, and executed by the processor 202.

As used herein, the term module refers to computer program logic used to provide the specified functionality. Thus, a module may be implemented in hardware, firmware, and/or software. As used herein, the term processor encompasses all kinds of apparatus, devices, and machines for processing data, including by way of example a programmable processor, a computer, a system on a chip, or multiple ones, or combinations, of the foregoing. The processor may include special purpose logic circuitry, e.g., an FPGA (field programmable gate array) or an ASIC (application-specific integrated circuit). The processor also may include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

The types of computing devices used by the entities and processes disclosed herein may vary depending upon the embodiment and the processing power required by the entity. The computing device 200 may be a mobile device, tablet, smartphone or any sort of computing element with the above-listed elements. For example, a data storage device, such as a hard disk, solid state memory or storage device, may be stored in a distributed database system comprising multiple blade servers working together to provide the functionality described herein. The computer devices may lack some of the components described above, such as keyboards 210, graphics adapters 212, and displays 218.

As would be appreciated by one of ordinary skill in the art, the embodiments disclosed herein may be implemented on any system, network architecture, configuration, device, machine, or apparatus, and is not to be construed as being limited to any specific configuration, network, or systems, even though an example system is shown and described with respect to FIG. 2. The embodiments herein may be suitably implemented on conventional computing devices, for example, computer workstations, on Internet based applications, on optical computing devices, neural computers, biological computers, molecular computing devices, and other devices. As may be appreciated by those skilled in the art, the present invention, in short, may be implemented on any system, automaton, and/or Turing machine.

An automaton is herein described as a mechanism that is relatively self-operating and designed to follow a predetermined sequence of operations or respond to encoded instructions. A Turing machine is herein described as an abstract expression of a computing device that may be realized or implemented on an infinite number of different physical computing devices. Examples of systems, automatons and/or Turing machines that may be utilized in performing the process of the present invention include, but are not limited to: electrical computers (for example, an International Business Machines (IBM) personal computer); neuro-computers (for example, one similar to the “General Purpose Neural Computer” described in U.S. Pat. No. 5,155,802, issued to Paul H. Mueller, on Oct. 13, 1992); molecular computers (for example, one similar to the “Molecular Automata Utilizing Single or Double-Strand Oligonucleotides” described in U.S. Pat. No. 5,804,373, issued to Allan Lee Schweiter et al., on Sep. 8, 1998); biological computers (for example, one similar to the biological computer presented by Ehud Shapiro, of the Computer Science and Applied Mathematics Department at the Weizman Institute of Science (Rehovot, Israel), at the Fifth International Meeting on DNA-Based Computers); and optical computers. For purposes of simplicity, such devices hereinafter are referred to as computers, as is commonly understood in the art. But, the embodiments disclosed herein are not limited being applied to such devices and may be accomplished upon any system or collection of systems capable of providing the features and functions identified herein.

Multiple computing devices 200 may be clustered to form a computing system of clients and servers. A client and server are generally remote from each other and typically interact through a communications network. The relationship of client and server arises by virtue of computer programs running on the respective computing devices and having a client-server relationship to each other. In some embodiments, a server transmits data (e.g., an HTML page) to a client (e.g., for purposes of displaying data to and receiving user input from a user interacting with the client device). Data generated at the client (e.g., a result of the user interaction) may be received from the client at the server.

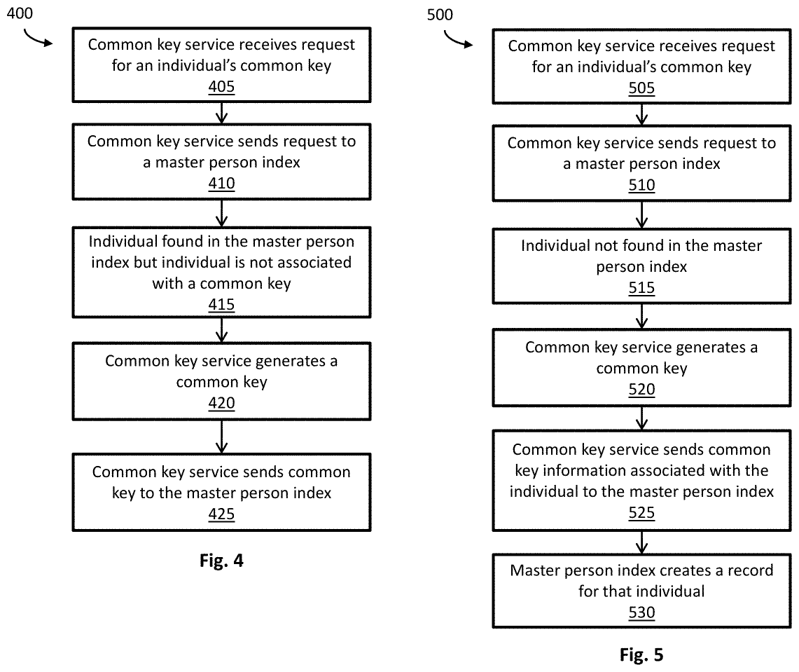

The active care relationship management (ACRM) system that provides an ACRS, as described below with respect to FIG. 3, the methods of generating and utilizing common keys in a common key service (CKS), as described below with respect to FIGS. 4-12, and the method and system for obtaining a patient's electronic consent, as described below with respect to FIGS. 13-18, may be implemented or performed partially or wholly on a processor, such as the one described above with regards to the computing device 200.

Referring to FIG. 3, there is shown an exemplary system 300 for collecting, maintaining, and updating patient information in accordance with an embodiment of the present disclosure. The system 300 includes an ACRM system that may be used to provide an ACRS, a plurality of health organization computing devices 310, a plurality of provider computing devices 315, and a plurality of patient computing devices 320. The ACRM system 305 includes an event detection module 330, a network update module 335, a network evaluation module 340, an alert generation module 345, and a database 355.

The ACRM system 305 is configured to assist with the collection, maintenance, and distribution of patient information. For example, the ACRM system 305 may receive patient information from the health organization computing devices 310, the provider computing devices 315, and the patient computing devices 320, and may process the received information to determine relationships between various entities, including patients, physicians, and other healthcare providers. The ACRM system 305 may generate and continuously update a semantic network based on the information received from the health organization computing devices 310, the provider computing devices 315, and the patient computing devices 320. The semantic network may be an interconnection of nodes, which may include patients, medications, medical conditions, providers, hospitals, clinics, etc., as described in U.S. patent application Ser. No. 15/847,506, which is incorporated herein in its entirety.

In some embodiments, the generation and update of the semantic network may be carried out by the event detection module 330 and the network update module 335. For example, the event detection module 330 may parse information received from the health organization computing devices 310, the provider computing devices 315, and the patient computing devices 320, and determine whether such information constitutes an event necessitating an update to the semantic network. The network update module 335 may add a node corresponding to either a provider or a patient to the semantic network if such nodes are not already present in the semantic network, and may add or modify the interconnection among the nodes. The network update module 335 also may store semantic information for the node interconnection. The network evaluation module 340 may analyze the semantic network to make inferences that may be relevant to the healthcare of one or more patients in the network. For example, the network evaluation module 340 may be configured to recognize patterns that may be used to predict healthcare outcomes or to select preventive care strategies for patients. The alert generation module 345 may be configured to provide alerts, such as an email, a text message, a phone call, or a mobile application notification, to any of the health organization computing devices 310, the provider computing devices 315, or the patient computing devices 320. The database 355 may store information about the semantic network, consent rules, policies, etc.

In some embodiments, the health organization computing devices 310 may be any type or form of computing device owned, operated, or otherwise accessed by a health organization, such as a health system, a hospital, a health plan, a medical insurer, a prescription benefit manager, a pharmacy, or a clinic. In some arrangements, each of the health organization computing devices 310 is implemented as at least one of a server, a desktop computer, or a laptop computer, such as the computing device described above with respect to FIG. 2. In some other arrangements, each of the health organization computing devices 310 may be a mobile computing device such as a tablet computing device, or a handheld computing device, such as a smartphone that may be accessed by an employee or other representative of the respective health organization.

Similarly, the provider computing devices 315, the patient computing devices 320, and the ACRM system 305 may also be any type or form of computing device owned, operated, or otherwise accessed by a provider, a patient, and a ACRS provider, respectively. In general, a provider may include a physician, a pharmacist, or any other person or group of people that provides healthcare to patients. In some embodiments, the provider computing devices 315, the patient computing devices 320, or the ACRM system 305 may be implemented as at least one of a server, a desktop computer, a laptop computer, a tablet computing device, or a handheld computing device.

A common key provides a way to match patients and their records across multiple organizations, applications, and services, such as an ACRS supported by an ACRM system (e.g., the ACRM system 305). With a common key, full and complete records for a patient may be accessed or modified as desired. Even if multiple records are associated with a patient, a common key may link the various records together. A CKS is safe and secure, protects confidentiality, and has high accuracy and data integrity of records shared across the multiple entities.

In an embodiment of the present disclosure, exchange of information between health organizations and providers may be performed utilizing CKSs. Each patient may be matched to a single identity, and that identity is assigned a unique common key. The common key may be an alphanumeric sequence. The common key is unique to each patient, and is used to link records stored, housed, and/or generated by multiple health organizations and providers.

The common key, when associated with the single identity of a patient, may be used to associate records of the patient across multiple entities and data stores across the healthcare market, such as primary care physician records, specialist records, hospital records, demographic records, billing information records, insurance information records, medical history records, care coordinator records, research databases, oncological databases, behavioral health system databases, pharmacy databases, etc.

A CKS may be used to link patients to their respective electronic medical records. Records may come from various formats and be stored across disparate systems. A common key may be used to link various records of a patient together. Additionally, a patient's demographic information (e.g., address, name, billing information, etc.) may change over time, making demographic information outdated or subject to error. By using a common key to keep track of records, complications and errors in treating patients due to incomplete information and records may be reduced.

A CKS may minimize mismatched record/patient associations and ensure that the record keeping is accurate. Matches and links between a patient and the patient's records may be affected across multiple organizations, applications, and services. This may lead to higher data integrity, which in turn improves patient safety by minimizing mistakes made by those utilizing the data. For example, a CKS may provide enhanced patient safety and care coordination by ensuring that medication and allergy information is tied to the correct person through a continuum of care, enhancing patient safety and potentially reducing the risk of medical errors. A CKS may also reduce work completed to coordinate care to patients across different organizations, applications, and services. This may also reduce cost of record keeping in service industries, such as health care. Furthermore, a CKS may be implemented to utilize current health information exchanges (HIE) and healthcare information technology (HIT) systems.

In an embodiment of the present disclosure, an HIT or HIE endpoint may be mapped to a master person index (MPI) using CKSs. For example, a governmental body such as a state government may maintain an MPI. The MPI may contain a record of every person in the state or known to the state. Such an MPI may be populated using information acquired through different government entities, such as entities that issue identification, process taxes, process health benefits, or schools. The CKS may insure that any medical records are mapped to a single identity of an individual as maintained on the MPI. In one embodiment of the present disclosure, the systems and methods disclosed herein for a CKS may be executed as a web service that utilizes application programming interface (API) calls to the MPI and/or HITs and HIEs. Such an embodiment may allow for easy integration of an MPI, HIT, and/or HIE with the CKS.

In one embodiment of the present disclosure, the CKS may be used in a case that tracks an active care relationship of a provider or providers with a patient in the healthcare industry. For example, a Patient X is admitted to a hospital. The hospital may be a part of a data sharing organization (DSO). Such a DSO may include other health care providers or hospitals that are a part of a single health system. A provider, such as a physician, at the hospital may generate an admit-discharge-transfer (ADT) notification that indicates Patient X has been admitted to the hospital. The ADT notification may be sent to an ACRS supported by an ACRM system (e.g., ACRM system 305) via the DSO that invokes the CKS. In other words, when the DSO attempts to store the ADT notification, the ACRS (which may be offered separately from or in conjunction with the CKS) will invoke or reference a common key from the CKS to determine and/or verify that the ADT notification is properly associated with Patient X and stored properly.

The CKS then utilizes demographic information received in conjunction with the ADT notification to search an MPI for the identity of Patient X. The MPI may be maintained by a state agency, as indicated above, or may be stored and maintained by another entity, such as the entity offering the CKS. If a match for Patient X is found in the MPI and Patient X is already associated with a common key, the MPI sends back to the CKS Patient X's unique common key. In this way, the ADT notification may be properly recorded and associated with the true identity of Patient X in the active care relationship files. Similarly, the common key may also be used by the DSO and the ACRS to determine other records relating to Patient X, which may facilitate proper care to Patient X while Patient X is treated at the hospital.

If the MPI finds a true identity of Patient X based on the demographic information, but Patient X is not yet associated with a unique common key, the MPI will request a common key from the CKS. A common key is generated by the CKS and that common key is assigned to Patient X. Similar to the above, the common key may then be added to the appropriate records. If the MPI does not find an identity match for Patient X or a common key, the MPI may create a new person record and request a new unique common key from the CKS. Examples of persons that may not have a record or common key may be a newborn or a person that has no previous affiliation with the body maintaining the MPI.

In another example, Patient X may be admitted to a hospital and the DSO associated with the hospital may already be aware of a common key associated with Patient X. Accordingly, when an ADT notification is generated, the DSO may send the ADT notification to the ACRS as well as the CKS along with the known common key. Accordingly, the records may be stored and associated with the common key, and the CKS may not have to look up the common key and match an identity in the MPI. However, in an alternative embodiment, the CKS may still look up the common key and the identity of Patient X in the MPI so as to verify that all of the information from the DSO is correct.

In another embodiment of the present disclosure, the CKS may be utilized to anonymize and make records more secure and private. For example, after a common key has been established for a patient and known by DSOs, health care providers, an MPI, the CKS, etc., personal identifying information about the patient may no longer be transmitted between those various entities. For example, a patient's records may be updated using only the patient's common key to identify which records to update, and the patient's name, birthdate, social security number, address, other demographic data, etc. may not be used to update the patient's medical records. In this way, the transmission of the patient's medical records and the medical records themselves may be de-identified.

In another embodiment of the present disclosure, a different use case may be applied in conjunction with a CKS. In the embodiment, a researcher may be studying a medical condition and utilizing records to perform a study. For example, the researcher may be studying the effectiveness of depression treatment as a cancer patient progresses through chemotherapy. Different treatments for a cancer patient may be administered by multiple providers for a single patient. Records for the different treatment may be generated and/or stored on multiple different systems. Accordingly, locating accurate information across disparate systems for a single patient may be difficult. For example, the name John Smith is very common, and if he is a subject of the study, linking together different medical records with various medical records numbers may be difficult. In other words, the researcher may find it difficult to piece together exactly which John Smith got what treatments, when the treatments were administered, and where the treatments were administered because, in part, each system may utilize different medical record numbers for the various John Smiths that exist. Accordingly, the researcher may utilize the common key system to determine which of the various records relating to a John Smith related to the John Smith that is the subject of the study. In this way, the research may be more easily and accurately conducted. In one embodiment, the records may not be associated with a common key, so the CKS matches each record to a true identity associated with the John Smith that is the subject to the study. In another embodiment, the researcher may find records that are already associated with a common key. In this instance, the researcher may utilize the CKS to request the common key of the John Smith that is the subject of the study. Once the common key for the correct John Smith is determined, the records that include the same common key may be easily identified, either by the researcher or automatically by the CKS. In other words, this embodiment allows researchers to link information from various systems to the appropriate patients using the CKSs.

The CKSs systems and methods disclosed herein overcomes difficulties in matching patients to facilitate the exchange of health information, despite medical information being stored in disparate systems. For example, one hospital registration/admission system may record gender as Male, Female, Unknown, while another hospital system may list M, F, or U instead. Furthermore, inconsistencies in patient demographics may also complicate accurate matching. For example, a patient's name may be entered as Jane Smith-Jones in one system; Jane Smith Jones (without the hyphenation (-)) in another system; and a third system may record her name as Jane Jones. In one system, Jane's address may be her most recent, while another system still has her address as her previous home; one may have her date of birth with year 1975 while the others have her birth year as 1957. In an embodiment of the present disclosure, when a provider or DSO requests records for a particular patient (or records associated with a particular common key), the system may format records according to the way the requesting party stores and transmits patient data and records. In this way, a requesting party may more easily interpret, display, and store the requested information according to the requesting party's system.

To streamline the exchange of information to support meaningful use and accountable care, electronic health care systems utilize reliable matching using a CKS as disclosed herein to determine that the right information is attributed to the right patient every time. The CKSs disclosed herein provide a consistent and reliable way to match patients across multiple organizations, applications and services. Such reliable matching capabilities ensure patient safety and high data integrity when data is shared. The CKS links information for individuals or organizations by using best practices for matching criteria to ensure that identifiers and attributes positively and accurately identify multiple types of entities. Examples of attributes that may be used to match identities include demographic information such as name, date of birth, gender, etc. In an alternative embodiment, information unique to the patient such as biometric information (fingerprint, palm scan, eye scan, etc.) may be used to determine an identity match. Individuals and entities that may use a CKS may include patients, beneficiaries, physicians and physician organizations, payers and health plans, hospitals and health systems, health care facilities, public health entities, etc. The CKSs disclosed herein may allow accurate data sharing through a wide variety of use cases, such as results delivery, hospital notifications, public health reporting, care coordination and patient safety, quality and administrative reporting, patient engagement, infrastructure (e.g. ACRS, statewide health provider directory, information security/identity management), standard consent, quality assurance systems, etc.

The CKS disclosed herein provides means to link information for individuals or organizations accurately in support of various use cases. For example, improved patient matching increases the volume of outbound ADT messages that accurately reach providers and payers, which helps a widespread health system operate more efficiently. The common key systems and methods disclosed herein may also leverage a state's MPI which may utilize robust processes for managing information about persons and de-duplicating entries with great accuracy.

In an embodiment of the present disclosure, the CKS receives a request for a patient's common key and passes the request to a respective state's MPI. Such a request may result in the following actions: (1) If the patient is found in the MPI, then the CKS creates a common key for the patient and cross-references it with the state's MPI to ensure accurate mapping across systems. (2) If a person is not found in the state's MPI, then the CKS assigns a common key and passes it to the state's MPI, which creates or modifies a record for that patient in the MPI. (3) If a potential match or possible duplicate is identified in the state's MPI the requestor receives a list of possible matches and is prompted to review the records in detail to identify the correct patient and/or to identify errors that caused the duplication in the MPI (e.g., misspelled name, incorrect birth date). The requestor then sends a message to the CKS which informs the MPI as to which of the duplicates is the right person. If the MPI is the source for the duplicate data, an MPI staff may review the data and correct duplicates and errors. Such a process may help ensure that person records are kept up-to-date, improving the integrity of the CKS and making both the MPI and CKS more robust. A record may be modified or created in the MPI by sending a message from the CKS that includes an action and any associated common keys. For example, the action in a message may be one or more of merge, update, or delete. Common keys to merge, update, or delete would be include in the message and associated with the appropriate action in the message.

Additionally, the CKS may utilize an ACRS supported by an ACRM system (e.g., ACRM system 305). An ACRM system or similar records management system may be exposed to the CKS via an API and then mapped to and integrated with the MPI using its APIs. This may yield an ease of technical implementation. For example, a Medicaid population that is serviced using an ACRS may be easily applied and used with a CKS.

FIG. 4 is a flow diagram illustrating a method 400 for generating a common key for known persons in accordance with an embodiment of the present disclosure. In alternative embodiments, fewer, additional, and/or different operations may be performed. Also, the use of a flow diagram is not meant to be limiting with respect to the order of operations performed. In an operation 405, a CKS receives a request for an individual's common key. In an operation 410, the CKS sends a request to an MPI. In an alternative embodiment, the MPI may instead be any database that stores information on persons and de-duplicates records on individual persons. In an operation 415, the individual is found in the MPI, but the individual is not associated with a common key. In an operation 420, the CKS generates a common key. In an operation 425, the CKS sends the common key to the MPI, such that the common key may be associated with the record of the individual in the MPI. In an alternative embodiment, the MPI and the CKS may not be separate systems. In other words, the common key system may store persons similar to an MPI, may determine the person matches in the MPI according to requests from data sharing organization devices or providers, and may use the common keys to de-duplicate records regarding single individuals. In other words, the common key system and the MPI may be the same or multiple systems that achieve the same functions as disclosed herein.

FIG. 5 is a flow diagram illustrating a method 500 for generating a common key for unknown persons in accordance with an embodiment of the present disclosure. In alternative embodiments, fewer, additional, and/or different operations may be performed. Also, the use of a flow diagram is not meant to be limiting with respect to the order of operations performed. In an operation 505, a CKS receives a request for an individual's common key. In an operation 510, the CKS sends a request to an MPI. In an operation 515, the individual is not found in the MPI. In an operation 520, the CKS generates a common key for the individual in response to a record of the individual not being found in the MPI. In an operation 525, the CKS sends the generated common key information associated with the individual to the MPI. In an operation 530, the MPI creates a record for that individual that includes identifying demographic information and the common key.

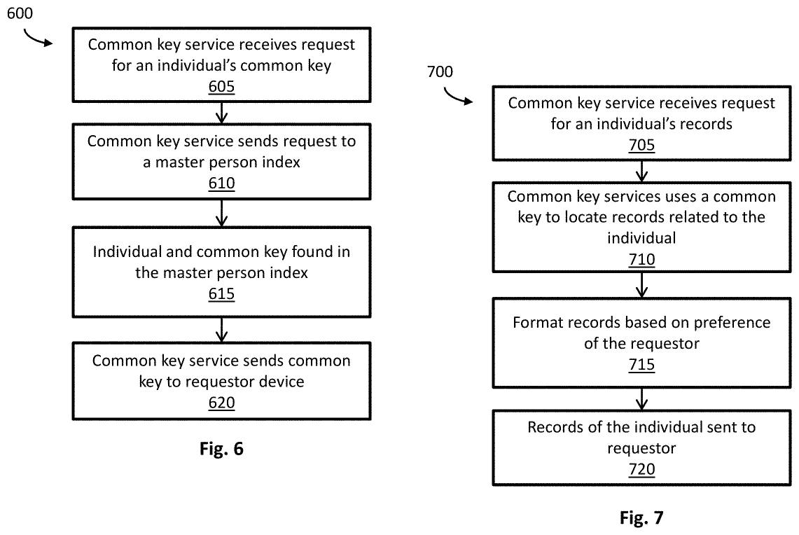

FIG. 6 is a flow diagram illustrating a method 600 for utilizing a known common key for a known person in accordance with an embodiment of the present disclosure. In alternative embodiments, fewer, additional, and/or different operations may be performed. Also, the use of a flow diagram is not meant to be limiting with respect to the order of operations performed. In an operation 605, a CKS receives a request for an individual's common key. In an operation 610, the CKS sends a request to an MPI. In an operation 615, the individual and an associated common key are found in the MPI. In an operation 620, the CKS sends the common key received from the MPI to the requestor device. Additionally, in another embodiment, the CKS may also associate a record from the requestor with the common key.

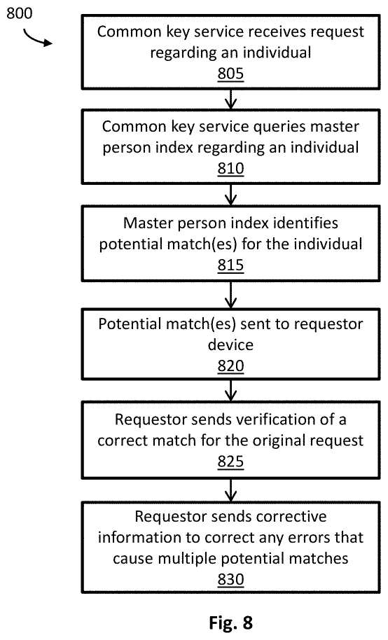

FIG. 7 is a flow diagram illustrating a method 700 for acquiring records using a common key in accordance with an embodiment of the present disclosure. In alternative embodiments, fewer, additional, and/or different operations may be performed. Also, the use of a flow diagram is not meant to be limiting with respect to the order of operations performed. In an operation 705, the CKS receives a request for an individual's records. In an operation 710, the CKS uses a common key to locate records related to the individual. In one embodiment, the records located may be stored in the common key system. In another embodiment, the records may be located on other systems, such as a DSO system, an ACRM system, a provider system, an MPI, or other locations where records may be stored. The common key utilized to locate or identify the records may be determined in various ways such as the methods described above with respect to FIGS. 4-6. In an operation 715, the records located are formatted based on a format preference of the requestor. This formatting may affect the way certain information/data is presented, and may affect what information/data is presented. In other words, the system may format the delivered records form and determine which records or portions of records should actually be delivered. In an operation 720, the records located and formatted are sent to the requestor.

FIG. 8 is a flow diagram illustrating a method 800 for verifying potential person matches in accordance with an embodiment of the present disclosure. In alternative embodiments, fewer, additional, and/or different operations may be performed. Also, the use of a flow diagram is not meant to be limiting with respect to the order of operations performed. In an operation 805, the CKS receives a request regarding an individual. In an operation 810, the CKS queries an MPI regarding the individual. In an operation 815, the MPI identifies potential matches (or a single potential match) for the individual. In an operation 820, the potential match(es) are sent to the requestor device. In an operation 825, the requestor sends verification of a correct match for the original request to the CKS and/or the MPI. In other words, the requestor confirms which of the potential match(es) is the correct match. In an operation 830, the requestor may also send corrective information to correct any errors that cause multiple matches. For example, some demographic information of an individual may be stored incorrectly in the MPI such that the MPI erroneously returned that individual as a potential match. The request may, in the operation 830, correct the error to prevent future mistakes and make the MPI and the CKS more accurate and helpful. In an alternative embodiment, confirmation of a correct match and/or corrective information regarding a record may be sent from an entity or device other than the requestor. For example, the CKS or the MPI may also be able to determine a correct match from potential match(es) and correct incorrect information in a record.

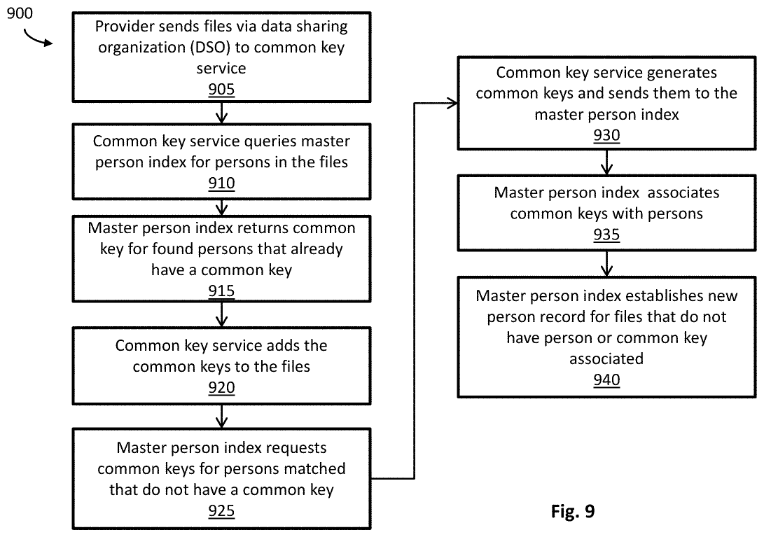

FIG. 9 is a flow diagram illustrating a method 900 for updating files using a CKS in accordance with an embodiment of the present disclosure. In alternative embodiments, fewer, additional, and/or different operations may be performed. Also, the use of a flow diagram is not meant to be limiting with respect to the order of operations performed. In an operation 905, a healthcare provider sends files via a DSO device (e.g., the health organization computing devices 310 or the provider computing devices 315) to a CKS. In an operation 910, the CKS queries an MPI for persons that match persons represented in the files sent from the DSO. In an operation 915, the MPI returns a common key for any matched individuals in the MPI database that match the persons in the files sent from the DSO. In the operation 915, the persons matched have already been assigned a common key. In an operation 920, the CKS adds the common keys attributed to the matched persons to the files. In an operation 925, the MPI requests common keys for persons matched that do not already have a common key assigned. In an operation 930, the CKS generates common keys for those persons and sends the common keys to the MPI. In an operation 935, the MPI associates the generated common keys with the person found in the MPI but previously not yet assigned a common key. In an operation 940, the MPI establishes a new person record for each of the persons from the files that do not yet have a matched person in the MPI or an associated common key. The method demonstrated in FIG. 9 may be utilized to intake and process large amounts of files and records that apply to many varying persons.

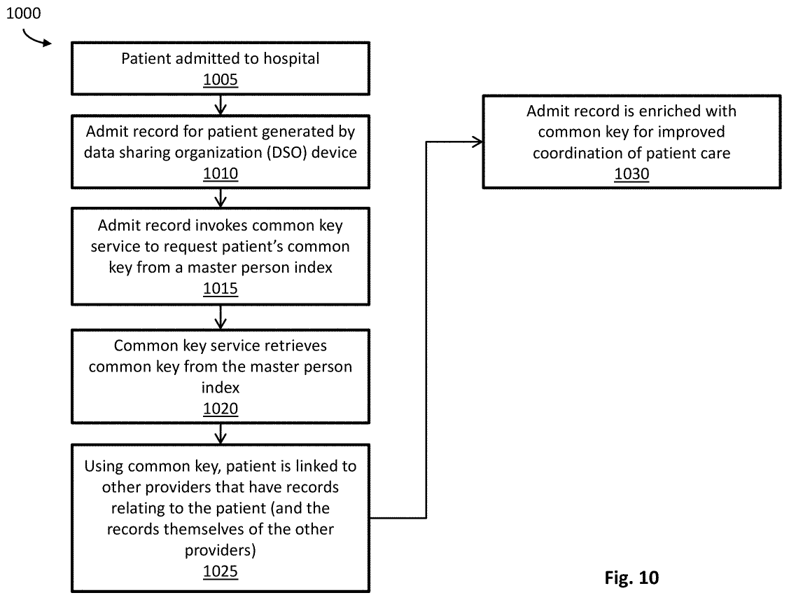

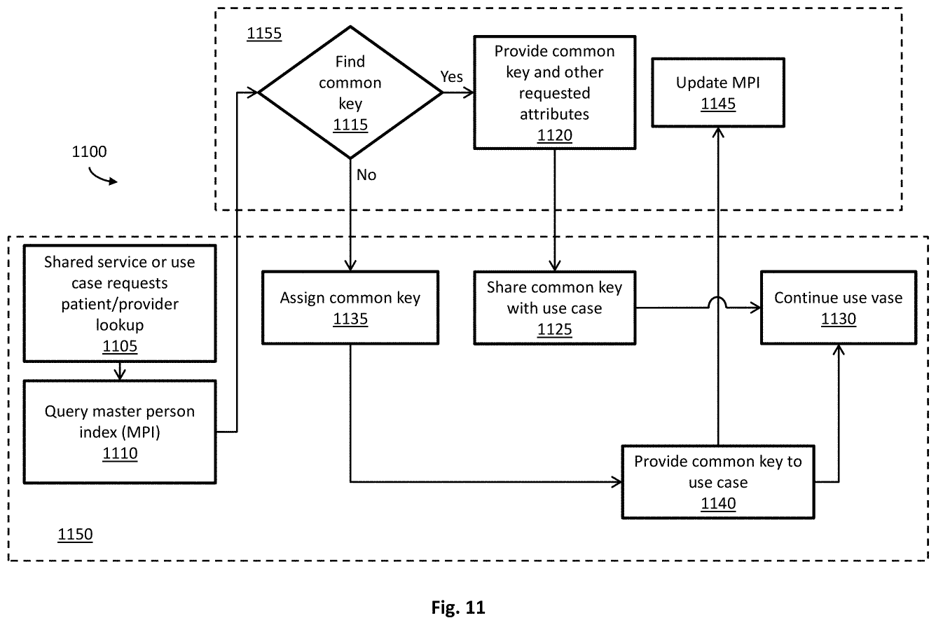

FIG. 10 is a flow diagram illustrating a method 1000 for utilizing a CKS in conjunction with a patient's hospital visit in accordance with an embodiment of the present disclosure. In alternative embodiments, fewer, additional, and/or different operations may be performed. Also, the use of a flow diagram is not meant to be limiting with respect to the order of operations performed. In an operation 1005, a patient is admitted to a hospital. In an operation 1010, an admit record for the patient is generated by a DSO device (e.g., a health organization computing device 310 or a provider computing device 315). In an operation 1015, the admit record and the DSO device invokes a CKS to request the patient's common key from an MPI. In an operation 1020, the CKS retrieves the patient's common key from the MPI. In alternative embodiments, the patient's common key may be generated similar to the common keys discussed above with respect to FIGS. 4 and 5. In an operation 1025, the CKS links the common key to link the patient to other providers that have records relating to that patient (and to the patient's records possessed by the other providers). In an operation 1030, the admit record is enriched with the common key for improved coordination of patient care. In another embodiment, the admit record may also be enriched with other information, such as the linked other providers and other provider records identified in the operation 1025.

FIG. 11 is a flow diagram illustrating a method 1100 for utilizing a CKS in accordance with an embodiment of the present disclosure. In alternative embodiments, fewer, additional, and/or different operations may be performed. Also, the use of a flow diagram is not meant to be limiting with respect to the order of operations performed. The method 1100 shows steps that may be performed by an MPI 1155, and steps that may be performed by a CKS 1150. In an operation 1105, a shared service or use case requests a patient and/or provider lookup from the CKS 1150. In an operation 1110, the CKS 1150 queries the MPI 1155. In an operation 1115, the MPI 1155 determines whether the patient and/or provider has a common key. If the patient and/or provider does have a common key, the MPI 1155 provides the common key and any other requested attributes (such as demographic information or other records) to the CKS 1150. In an operation 1125, the CKS 1150 in turn provides that information and the common key to the requestor, shared service, use case, etc. In an operation 1130, the CKS 1150 then continues the use case, shared service, etc. In other words, the shared service, use case, etc. utilizes the provided information and/or common key for a purpose for which the information and/or common key was requested, such as obtaining or updating a record. In an operation 1135, the CKS 1150 assigns a common key because the MPI 1155 did not find a common key in the operation 1115. In an operation 1140, the generated common key is provided to the use case, shared service, requestor, etc. In an operation 1145, the generated common key is provided to the MPI 1155, so that the MPI 1155 may be updated with the generated common key. In the operation 1145, the generated common key is associated in the MPI 1155 with the patient and/or provider that the common key has been generated for, such that the common key may be subsequently associated with that patient and/or provider. In the operation 1130, the CKS 1150 then continues the use case, shared service, etc. In other words, the shared service, use case, etc. utilizes the provided information and/or common key for a purpose for which the information and/or common key was requested, such as obtaining or updating a record.

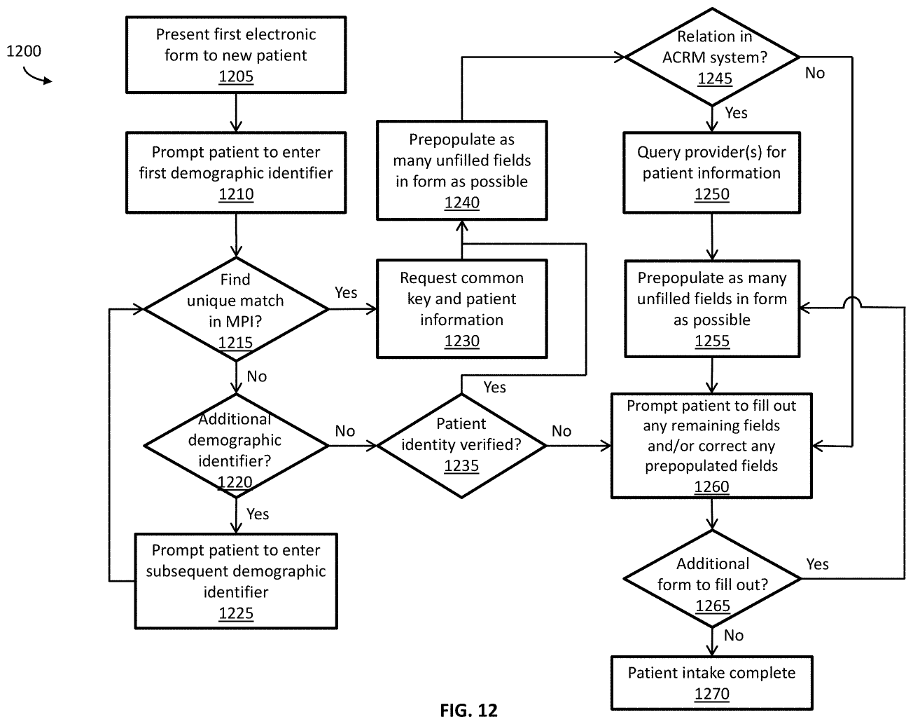

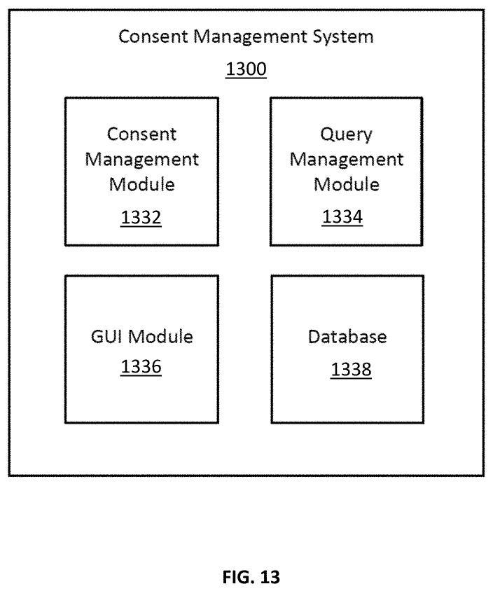

FIG. 12 is a flow diagram illustrating a new patient's intake process 1200 at a health organization or a provider in accordance with an embodiment of the present disclosure. In alternative embodiments, fewer, additional, and/or different operations may be performed. Also, the use of a flow diagram is not meant to be limiting with respect to the order of operations performed. In an operation 1205, a DSO device (e.g., a health organization computing device 310 or a provider computing device 315) presents, on its display, the new patient with an electronic version of a first of one or more intake or consent forms. In an operation 1210, the DSO device prompts the patient to enter a first demographic identifier, which may for example be the patient's first name. Once the patient enters the first demographic identifier, in an operation 1215, the DSO device invokes a CKS to determine if there is a unique match for the patient in an MPI. If there is no match, in an operation 1220, the DSO device determines if there is an additional demographic identifier (e.g., middle initial, last name, zip code, date of birth, gender, last four digits of social security number, phone number, email address, etc.) that the patient may enter. If so, in operation 1225, the DSO device prompts the patient to enter a subsequent demographic identifier. The DSO device then may repeat the operations 1215-1225 until either a unique match is found in the MPI for the patient at operation 1215 or there is a determination that there is no additional demographic identifier for the patient to enter at operation 1220.

If a unique match is found at the operation 1215, at an operation 1230, the DSO device requests, from the CKS, the patient's common key and all additional information that the MPI has on the patient. The MPI typically stores all demographic identifiers of the patients. If there is no additional demographic identifier to be entered, the DSO device invokes, at an operation 1235, an identity proofing service to determine if the identity of the patient may be verified. An identity proofing service is described in U.S. patent application Ser. Nos. 14/642,092 and 14/949,395, and may employ knowledge-based authentication and/or optional biometric identification. When either the patient's common key and MPI information are received at the operation 1230 or if the patient's identity is verified by the identity proofing service at the operation 1235, the DSO device prepopulates, at an operation 1240, as many unpopulated fields in the electronic form as possible using information from the MPI or the identity proofing service.

At an operation 1245, the DSO device invokes an ACRM system (e.g., ACRM system 305) that is used to provide an ACRS to determine, using either the patient's common key from the operation 1230 or the patient's verified identity from the operation 1235, if there is any known relationship between the patient and other providers where information about the patient may be stored. For every provider with which the patient has a relationship, the DSO device queries, at an operation 1250, the provider for information about the patient. The operation 1250 may involve retrieving an electronic address for the provider from a provider directory utility and invoking an intelligent query broker (as described in U.S. patent application Ser. No. 15/855,319, which is incorporated herein in its entirety) to query the provider at its electronic address for information about the patient.

Once additional information about the patient is received from other provider(s), the DSO device prepopulates as many remaining unpopulated fields in the electronic form as possible at an operation 1255. At an operation 1260, the DSO device prompts the patient to populate any remaining fields and/or correct any prepopulated fields, and electronically consent to and sign the electronic form. The operation 1260 may also be reached from the operation 1235 when the identity of the patient may not be verified by the identity proofing service.

At an operation 1265, the DSO device determines if there is any additional electronic intake or consent form for the patient to populate. If there is any additional electronic form, the DSO device loops back to operation 1255 and prepopulates as many fields as possible in the new form using information obtained from the MPI, the patient's identity verification, or provider(s) with the which patient has a relationship. Then, at the operation 1260, the DSO device prompts the patient to populate any remaining fields. If there is no additional form for the patient to populate at the operation 1265, the patient intake process 1200 is completed at an operation 1270. The patient intake process 1200 thus allows a patient to create intake forms once and enter every piece of information once, allowing secure communication and accurate sharing of the patient's information regardless of geographical location of health organizations or providers.

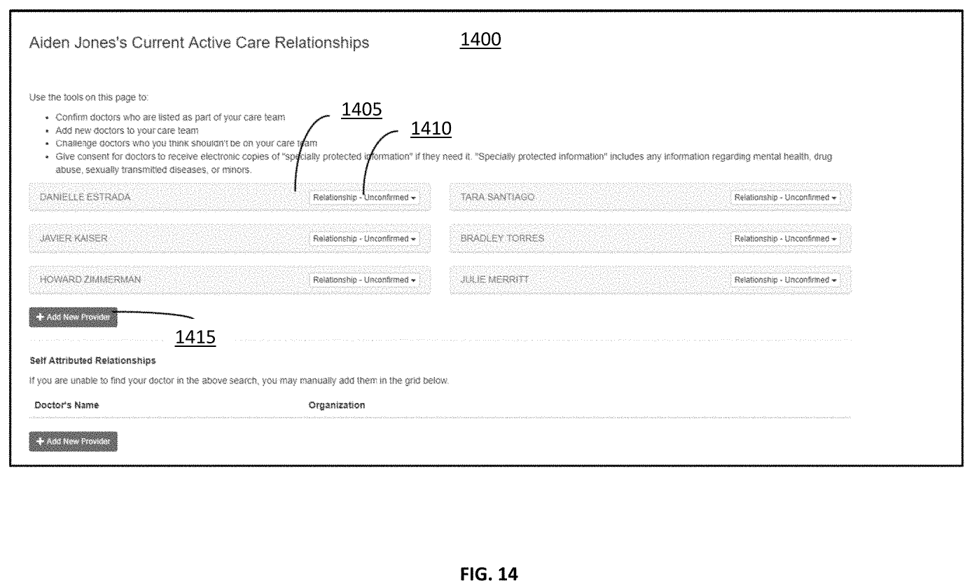

FIG. 13 illustrates a consent management system 1300 in accordance with an embodiment of the present disclosure. The consent management system 1300 may be used to provide an eConsent management service, and includes a consent management module 1332, a query management module 1334, a graphical user interface (GUI) module 1336, and a database 1338. In some implementations, the GUI module 1336 of the consent management system 1300 can be configured to generate and provide one or more GUIs that can enable a patient to provide consent for the sharing of the patient's health information. For example, such a GUI can be used to allow the patient to provide the consent information used by the consent management module 1332 to generate or modify the consent record for the patient. In some implementations, the GUI module 1336 can generate information for such a GUI and can transmit the information to a patient computing device (e.g., the patient computing device 320 in FIG. 3) in a format that allows the GUI to be rendered via a display device or other output device of the patient computing device. The patient can then interact with the patient computing device, for example via one or more input devices included in or otherwise accessible by the patient computing device, to provide the consent information via the GUI. The consent information can then be transmitted from the patient computing device to the consent management module 1332, which can use the consent information to generate or update the consent record for the patient. FIGS. 14-17 show example GUIs that can be generated by the GUI module 1336.

FIG. 14 illustrates a first example GUI 1400 that can be provided to a patient in accordance with an embodiment of the present disclosure. For example, information corresponding to the GUI 1400 can be generated by the GUI module 1336 and transmitted to a patient computing device (e.g., the patient computing device 320 in FIG. 3) to cause the patient computing device to render the GUI 1400 to a user of the patient computing device. In some implementations, the GUI 1400 can allow the user (e.g., a patient) to provide information corresponding to active healthcare relationships that the patient has with any number of providers or other healthcare organizations. As shown, the GUI 1400 includes text notifying the user that the user can use the GUI to add or confirm healthcare providers who are part of the user's care team, and to challenge providers who the user believes should not be part of the user's care team. The GUI 1400 includes a plurality of fields such as the field 1405, each of which indicates the name of a provider that may be part of the user's care team. In some implementations, the fields 1405 may be pre-populated (e.g., populated without any input from the user). For example, the fields 1405 may be populated to include any or all of the healthcare organizations or providers that are linked to the user. For each named provider, the GUI 1400 includes a respective dropdown menu such as the dropdown menu 1410. The dropdown menu 1410 can be used to indicate whether the user wishes to confirm or dispute that the respective provider as part of the user's care team. The GUI 1400 also includes a button 1415 that can be selected to add a new provider who is not currently listed in the GUI 1405. For example, if the user recently began seeing a new healthcare provider who is not yet listed as a part of the user's care team, the user may use the button 1415 to add the new healthcare provider to the user's care team.

In some implementations, the user can interact with the dropdown menu 1410 and the button 1415 using any suitable interface device, such as a mouse, a trackball, a stylus, a touchscreen, a keyboard, or any other type of input device that can allow the user to interact with the dropdown menu 1410 or the button 1415. In some implementations, the GUI can be configured to capture input selections made by the user through the interface elements of the GUI 1400 including the dropdown menu 1410 and the button 1415, and to transmit information corresponding to the user's input selections to the consent management system 1300 or the ACRM system 305. For example, information corresponding to providers that the user confirms or disputes can be transmitted to the ACRM system 305 in order to allow the ACRM system 305 to update the data structure to indicate the confirmed or disputed relationship between the patient and the selected providers, as described above.

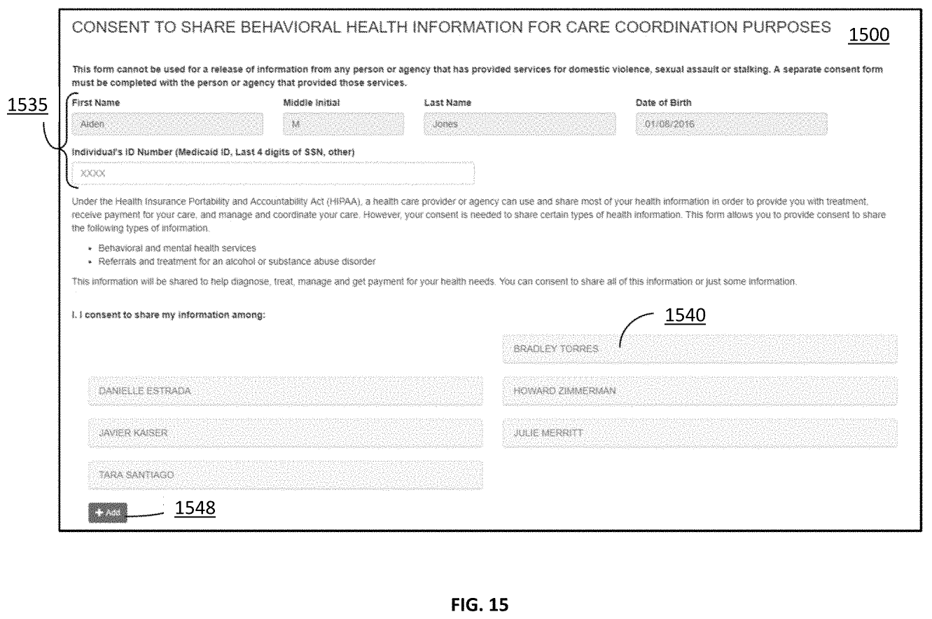

FIG. 15 illustrates a second example GUI 1500 that can be provided to a patient in accordance with an embodiment of the present disclosure. In some implementations, the GUI 1500 can allow the user to provide consent for health information relating to behavioral and mental health services, as well as referrals and treatment for alcohol or substance abuse disorder, with one or more providers or healthcare organizations. The GUI 1500 includes a plurality of fields 1535 corresponding to identification information for the user. In some implementations, the user can enter the user's identification information, for example using a keyboard or other user input device, and the GUI 1500 can be configured to transmit the information to the consent management system 1300. In some implementations, at least a portion of the user's identification information may be pre-populated in the GUI 1500 before the user provides any input. The GUI 1500 also includes a plurality of fields 1540 each corresponding to a respective provider or healthcare organization to whom the consent applies. In some implementations, the user can use a pointing device or other user input device to remove or modify providers shown in these fields 1540. The user can also select the button 1548 to add a new provider or health organization not already displayed in the GUI 1500.

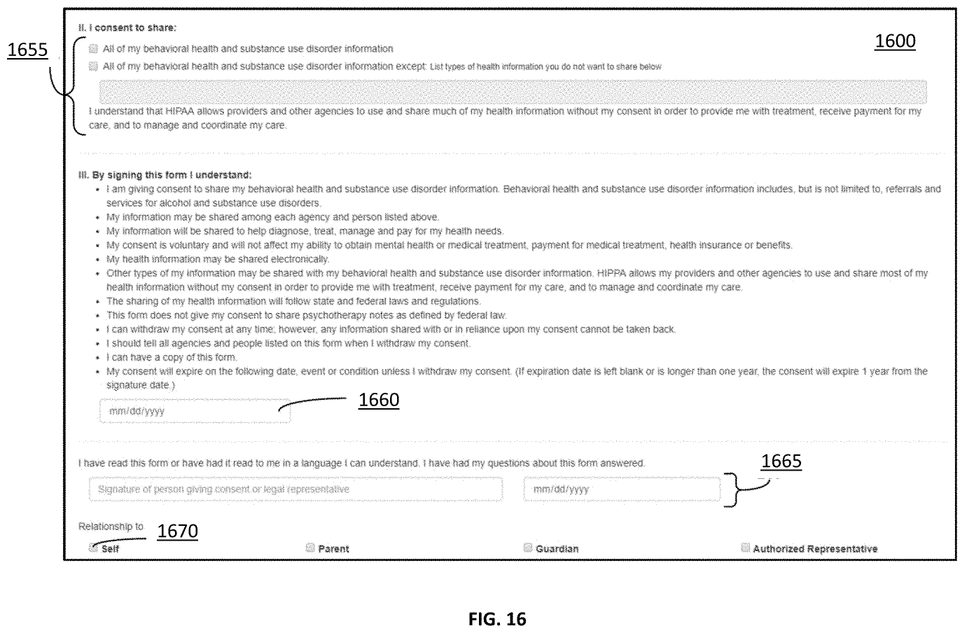

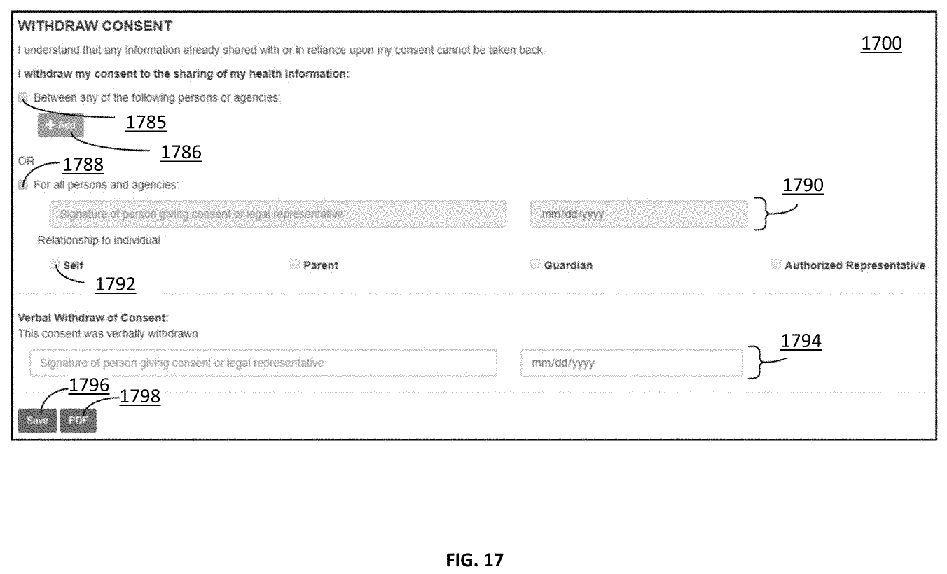

After the user has made selections through the GUI 1500, the third example GUI 1600 shown in FIG. 16 can be displayed to the user. The GUI 1600 includes a plurality of user interface elements 1655, which can include checkboxes and text fields, that allow a user to select a variety of types of information for which the user's consent applies. The GUI 1600 also includes text notifying the user of the consequences of providing consent, as well as signature fields 1665 and an optional expiration date field 1660. The GUI 1600 also includes a plurality of relationship fields 1670 asking the user to confirm the user's relationship to the patient for whom consent is being provided. In some implementations, after the user has made selections via the GUIs 1500 and 1600, information corresponding to the selections can be transmitted to the consent management system 1300. In some implementations, the consent management system 1300 can use the information to generate or modify a consent record for the user, which can be stored in the database 1338.

FIG. 17 illustrates a fourth example GUI 1700 that can be provided to a patient in accordance with an embodiment of the present disclosure. In some implementations, the GUI 1700 can be provided to a user via a patient computing device (e.g., the patient computing device 320 in FIG. 3) to allow the user to withdraw consent for the user's health information to be shared by a provider or health organization to whom the user had previously provided consent. The GUI 1700 provides a checkbox 1785 that allows the user to specify the particular providers or health organizations for whom the user wishes to revoke consent for data sharing. For example, after selecting the checkbox 1785, the user can use the button 1786 to add the providers or health organizations for whom the user wishes to revoke consent for data sharing. Alternatively, the user can select the checkbox 1788 to withdraw consent all providers and health organizations to share the user's health information, without any need to list the providers or health organizations for whom the consent is to be revoked. The GUI 1700 also provides signature fields 1790, relationship checkboxes 1792 for the user to indicate the user's relationship to the patient for whom consent is being revoked. If consent was withdrawn verbally, such as during a medical procedure undergone by the patient, the patient can confirm this withdrawal via the verbal withdrawal of consent fields 1794, which require a signature and date.

The GUI 1700 also includes a save button 1796 that can allow the user to save a record of the information entered via the GUI 1700. In some implementations, selecting the save button 1796 can cause the information to be saved locally on the patient computing device. In some implementations, selecting the save button 1796 can cause the information to be transmitted to the consent management system 1300, to allow the consent record for the patient to be updated accordingly. The GUI 1700 also includes a PDF button 1798, which the user can select to view a copy of the information entered into the GUI 1700 in portable document format (.pdf) format.

The GUIs 1400, 1500, 1600, and 1700 shown in FIGS. 14-17 can be displayed on a patient computing device (e.g., the patient computing device 320 in FIG. 3) in any suitable format. For example, in some implementations the GUIs 1400, 1500, 1600, and 1700 can be displayed as part of a mobile application executing on the patient computing device. In some implementations, the GUIs 1400, 1500, 1600, and 1700 can be rendered within a web browser application executing on the patient computing device. For example, the user of the patient computing device can cause the patient computing device to render the GUIs 1400, 1500, 1600, and 1700 within the web browser application by accessing a uniform resource locator (URL) of a website hosted by the consent management system 1300, which in turn can cause the GUI module 1336 to generate and transmit information corresponding to the GUIs 1400, 1500, 1600, and 1700 to the patient computing device.

In some implementations, the consent management system 1330 can provide the GUIs 1400, 1500, 1600, and 1700 to the patient computing device in response to determining that a provider or health organization has been denied permission to share or access the patient's health information. For example, the consent management system 1330 can receive a query from a health organization computing device (e.g., the health organization computing device 310 in FIG. 3) or a provider computing device (e.g., the provider computing device 315 in FIG. 3), and the determine that the patient has not provided consent for the health organization or provider associated with the query to share or access the patient's health information. In response, the GUI module 1336 can generate and transmit information corresponding to the GUIs 1400, 1500, 1600, and 1700 to the patient computing device associated with the patient, in order to allow the patient to update the consent to include the health organization or provider associated with the query, if the user so desires.

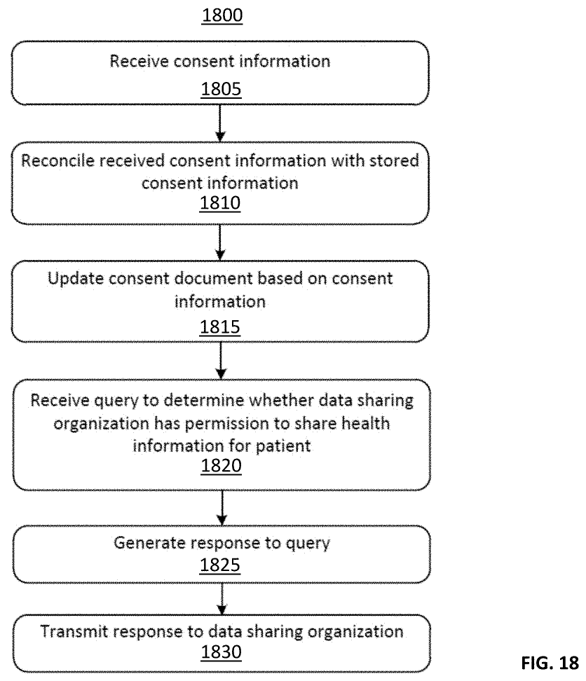

FIG. 18 illustrates a flowchart of a first example method 1800 for managing data privacy in accordance with an embodiment of the present disclosure. In some implementations, the method 1800 can be performed by the consent management system 1300 shown in FIG. 13. The method 1800 includes receiving consent information (operation 1805), reconciling the received consent information with stored consent information (operation 1810), updating a consent record based on the reconciled consent information (operation 1815), receiving a query to determine whether a data sharing organization has permission to share health information for a patient (operation 1820), generating a response to the query (operation 1825), and transmitting the response to the data sharing organization (operation 1830).

Referring again to FIG. 18, the method 1800 includes receiving consent information (operation 1805). In some implementations, the consent information can be received from a patient computing device such as the patient computing devices 320 of FIG. 3. For example, the consent information can be collected based on user inputs via a GUI displayed on the patient computing device. The consent information can include a first patient identifier, which can uniquely identify the patient for whom the consent information is supplied. For example, the consent information can include the patient's name, social security number, other identification number, or any combination of these or other types of identifying information. In some implementations, the consent information can also include an indication that the patient consents to the sharing of health information with at least one health organization. For example, the consent information can also include a health organization identifier uniquely identifying a health organization for whom the patient is providing consent. In some implementations, the consent information can also include a provider identifier for a healthcare provider, such as a physician, for whom the patient is providing consent.

The method 1800 includes reconciling the received consent information with stored consent information (operation 1810). In some implementations, the consent management module 132 can perform the reconciliation based on the received consent information and one or more consent records stored in a database. In some implementations, the consent record can be any type or form of data structure, including a data fractal. For example, the consent record may be at least a portion of an entry stored in a ledger. In some implementations, the consent management module 1332 may store a set of policies corresponding to common data formatting inconsistencies, as well as policies for addressing or correcting the inconsistencies. For example, the policies may include one or more rules or steps to be performed to convert data included in the received consent information into a format that is consistent with the formatting of the stored consent information. In some implementations, reconciling the received consent information with the stored consent information can include identifying redundant data (e.g., the same data included in both the received consent information and the stored consent information) and discarding the redundant data. In some implementations, the consent management module 1332 can use a common key service (as described above) to perform at least a portion of the reconciliation.

The method 1800 includes updating the consent record based on the consent information (operation 1815). In some implementations, the consent management module 1332 can update the consent record based on the consent information received in operation 1805. In some implementations, the consent management module 1332 can generate a new consent record corresponding to the received consent information. For example, the consent management module 1332 can generate the consent record in the form of any type of data structure configured to store the consent information. In some implementations, the consent record can be formatted as an extensible markup language (XML) document. The consent record can be assigned to or otherwise associated with the particular patient who provided the consent information. In some implementations, if a consent record already exists for the patient, the consent management module 1332 can instead modify the existing consent record based on the consent information received in operation 1805, rather than generating a new consent record. The consent management module 1332 can store the consent record, for example, in the database 1338.

The method 1800 includes receiving a query to determine whether a data sharing organization has permission to share health information for a patient (operation 1820). The query can be received, for example, by the query management module 1334 from a health organization computing device 310 or a provider computing device 315. The query can include a second patient identifier corresponding to the patient for whom consent to share health information is sought. In addition, the query may include an identifier of a health organization or provider with whom the health organization initiating the query would like to share the patient's health information. For example, the health organization that initiates the query may wish to share the patient's health information with another health organization of provider, but may be required to obtain the patient's consent before sharing the health information.

The method 1800 includes generating a response to the query (operation 1825). In some implementations, the consent management module 1332 can first determine whether the data sharing organization has permission to share the patient's health information, based on the query and the patient's stored consent record. For example, the consent management module 1332 can make the determination by identifying a match between the second patient identifier included in the query and the first patient identifier associated with the consent information received in operation 1805. This match can allow the consent management module 1332 to locate the consent record for the appropriate patient. The consent management module 1332 can also identify a match between the first identifier of a health organization or other entity for whom the patient has provided consent to data sharing as recorded in the patient's consent record, and the identifier of the data sharing organization that initiated the query. In some implementations, the consent management module 1332 can also determine whether the patient's consent is still valid (i.e., that the consent has not been revoked by the patient or expired at the time the query is received). In some implementations, the consent management module 1332 can also determine whether the patient's consent applies to the category or type of information specified in the query.

If the consent management module 1332 determines that a valid consent exists for the data sharing organization, the query management module 1334 can generate a response to the query indicating that the data sharing organization is authorized to share the health information of the patient. Otherwise, if the consent management module 1332 determines that a valid consent does not exist for the data sharing organization, the query management module 1334 can generate a response to the query indicating that the data sharing organization is not authorized to share the health information of the patient. The method 1800 also includes transmitting the response to the data sharing organization (operation 1830).

At this point, it should be noted that determining the level of coverage and premium of a liability insurance to be provided to a healthcare provider as described above may involve the processing of input data and the generation of output data to some extent. This input data processing and output data generation may be implemented in hardware or software. For example, specific electronic components may be employed in a computer server or similar or related circuitry for implementing the functions associated with intaking a patient at a provider in accordance with the present disclosure as described above. Alternatively, one or more processors operating in accordance with instructions may implement the functions associated with determining the level of coverage and premium of a liability insurance to be provided to a healthcare provider in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for limiting risks in electronically communicating patient information according to a set of instructions stored on a memory of a computing device and executed by a processor of the computing device, the method comprising the steps of:
determining a number of electronic security related services employed by a healthcare provider that electronically communicates patient information;
calculating a level of coverage of a liability insurance to be provided to the healthcare provider based on the number of services; and
calculating a premium cost of the liability insurance based on the number of services.

2. The method of claim 1, wherein the services include one or more of an active care relationship service, a common key service, and an electronic consent service.

3. The method of claim 1, wherein the services are provided by a health information service provider.

4. The method of claim 1, wherein the services ensure that patient information communicated by the healthcare provider conforms to data standards and security measures.

5. The method of claim 1, wherein the calculated premium cost is lower when the healthcare provider uses more services.

6. The method of claim 1, wherein the calculated premium cost is higher when the healthcare provider uses fewer services.

7. The method of claim 1, wherein the calculated level of coverage is higher when the healthcare provider uses more services.

8. The method of claim 1, wherein the calculated level of coverage is lower when the healthcare provider uses fewer services.

9. At least one processor readable storage medium storing a computer program of instructions configured to be readable by at least one processor for instructing the at least one processor to execute a computer process for performing the method as recited in claim 1.

10. A system for limiting risks in electronically communicating patient information, the system comprising:
one or more processors communicatively coupled to a network, wherein the one or more processors are configured to:
determine a number of electronic security related services employed by a healthcare provider that electronically communicates patient information;
calculate a level of coverage of a liability insurance to be provided to the healthcare provider based on the number of services; and
calculate a premium cost of the liability insurance based on the number of services.

11. The system of claim 10, wherein the services include one or more of an active care relationship service, a common key service, and an electronic consent service.

12. The system of claim 10, wherein the services are provided by a health information service provider.

13. The system of claim 10, wherein the services ensure that patient information communicated by the healthcare provider conforms to data standards and security measures.

14. The system of claim 10, wherein the calculated premium cost is lower when the healthcare provider uses more services.

15. The system of claim 10, wherein the calculated premium cost is higher when the healthcare provider uses fewer services.

16. The system of claim 10, wherein the calculated level of coverage is higher when the healthcare provider uses more services.

17. The system of claim 10, wherein the calculated level of coverage is lower when the healthcare provider uses fewer services.

18. An article of manufacture for limiting risks in electronically communicating patient information, the article of manufacture comprising:
at least one processor readable storage medium; and
instructions stored on the at least one medium;
wherein the instructions are configured to be readable from the at least one medium by at least one processor and thereby cause the at least one processor to operate so as to:
determine a number of electronic security related services employed by a healthcare provider that electronically communicates patient information;
calculate a level of coverage of a liability insurance to be provided to the healthcare provider based on the number of services; and
calculate a premium cost of the liability insurance based on the number of services.
